(19) United States
(12) Patent Application Publication
(10) Pub. No.: US 2016/0150066 A1
(43) Pub. Date: May 26, 2016

(54) Method and Apparatus for Providing In-Vehicle Bluetooth Pairing

(71) Applicants: Hyundai Motor Company, Seoul (KR); Kia Motors Corporation, Seoul (KR)

(72) Inventor: Seong Soo Yae, Osan (KR)

(21) Appl. No.: 14/645,054

(22) Filed: Mar. 11, 2015

(30) Foreign Application Priority Data
Nov. 26, 2014 (KR) 10-2014-0166491

(51) Int. Cl. H04M 1/60; H04W 76/02; H04L 29/12; H04B 1/3822; H04W 4/00

(52) U.S. Cl. CPC H04M 1/6075; H04B 1/3822; H04W 4/008; H04L 61/6022; H04W 76/021

(57) ABSTRACT

An in-vehicle Bluetooth pairing providing method and an apparatus using the same are disclosed. The Bluetooth pairing method in an in-vehicle head unit includes: initiating a Bluetooth automatic connection procedure with a pre-registered first user device upon application of power; canceling the initiated automatic connection procedure in accordance with user input; searching for a connectable user device; establishing a logical link with the searched user device; and transmitting a connection request message to the user device through the established logical link.

### CROSS-REFERENCE TO RELATED APPLICATION

This application claims priority to and the benefit of Korean Patent Application No. 10-2014-0166491, filed on Nov. 26, 2014, which is hereby incorporated by reference as if fully set forth herein.

### BACKGROUND

1. Technical Field

The present disclosure relates to in-vehicle Bluetooth pairing methods and, more particularly, to methods and apparatuses for providing in-vehicle Bluetooth pairing, which enable more rapid and convenient pairing owing to simplified user pairing manipulation steps.

2. Discussion of the Related Art

Recent rapid development of information technology (IT) has produced a significant influence on the vehicle industry, and various IT technologies have been implemented in vehicles. Particularly, in recent years, significant interest has surrounded a vehicle pairing technology combined with a communication device, such as a smartphone, to provide various useful services.

Generally, when a vehicle is started, a Bluetooth-based function of an in-vehicle head unit having Bluetooth hands-free capability is automatically enabled, and, as a result, the in-vehicle head unit enters a pairing standby mode. At this time, a driver of the vehicle performs a pairing operation through selection of a predetermined menu item on the in-vehicle head unit and the smartphone. When the pairing operation is completed, the driver may have a telephone conversation in a Bluetooth hands-free state.

Users who are familiar and comfortable with Bluetooth technology can easily perform an in-vehicle Bluetooth pairing operation as a result of commercialization of Bluetooth technology. However, users who are not familiar or comfortable with Bluetooth technology may have difficulty in performing such a complicated pairing procedure and thus may not use the technology.

However, the in-vehicle Bluetooth pairing technology is directly correlated with vehicle safety and provides convenience to drivers during driving. For these reasons, in North America, a seller provides a Bluetooth pairing service, instead of a driver, when selling a vehicle equipped with a Bluetooth. After selling, though, it is still necessary for the driver to perform a complicated pairing procedure, including registering a new phone for Bluetooth communication or deleting a pre-registered phone, which inconveniences the driver. Accordingly, in recent years, out-of-band (OOB) type simple pairing methods based on simple secure pairing (SSP), pairing methods using a pairing application, and the like have been studied.

### SUMMARY

Accordingly, the present disclosure is directed to a method and apparatus for providing in-vehicle Bluetooth pairing that substantially obviate one or more problems due to limitations and disadvantages of the related art. One object of the present disclosure is to provide a method for providing in-vehicle Bluetooth pairing. Another object of the present disclosure is to provide an in-vehicle pairing method that is capable of providing a more rapid and convenient pairing service by simplifying user pairing operation steps. Another object of the present disclosure is to provide an in-vehicle pairing method that is capable of simultaneously requesting several in-vehicle user devices for pairing. A further object of the present disclosure is to provide an in-vehicle pairing method that is capable of setting a plurality of logical links based on the quality of radio signals received from a plurality of user devices and simultaneously pairing with the user devices through the logical links.

Additional advantages, objects, and features of the disclosure will be set forth in part in the description which follows and in part will become apparent to those having ordinary skill in the art upon examination of the following or may be learned from practice of the present embodiments. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, the present disclosure provides a method for providing in-vehicle Bluetooth pairing and an apparatus using the same.

According to embodiments of the present disclosure, a Bluetooth pairing method in an in-vehicle head unit includes: initiating a Bluetooth automatic connection procedure with a pre-registered first user device upon application of power; canceling the initiated automatic connection procedure in accordance with user input; searching for a connectable user device; establishing a logical link with the searched user device; and transmitting a connection request message to the searched user device through the established logical link.

The logical link may be an asynchronous connectionless (ACL) link, and a maximum number of ACL links which are permitted to be simultaneously established in the in-vehicle head unit may be predefined.

The Bluetooth pairing method may further include, when a plurality of user devices is searched, the searched user device being one of the plurality of user devices, measuring a received signal strength indicator (RSSI) of each searched user device, and address information corresponding to each of the searched user devices may be stored in a memory and arranged therein according to the measured RSSI.

The address information may include at least one of media access control (MAC) address information corresponding to the searched user devices and Bluetooth address information assigned to Bluetooth modules equipped in the searched user devices, and the connection request message may be transmitted using the address information.

The Bluetooth pairing method may further include ranking the searched user devices according to the measured RSSI, and sequentially transmitting the connection request message to each of the searched user devices in an order according to the ranking.

The RSSI may be measured in a link management protocol (LMP) layer of a Bluetooth module equipped in the in-vehicle head unit.

The connectable user device may be a user device having an enabled Bluetooth function and an enabled discoverable mode.

The connection request message may include vehicle information and a passkey value corresponding to the in-vehicle head unit.

The user device, after receiving the connection request message, may display a predetermined pop-up notification window for approval on a screen thereof, and the pop-up notification window may display the vehicle information and the passkey value.

Approval of a connection request that is indicated by the connection request message may occur when a user-inputted passkey value is identical to the passkey value displayed in the pop-up notification window.

The Bluetooth pairing method may further include displaying an automatic connection screen including a “cancel” button and an “add new” button upon initiation of the automatic connection procedure, and the connectable user device may be searched for upon selection of the “add new” button.

Furthermore, according to embodiments of the present disclosure, a Bluetooth pairing method in a user device being capable of Bluetooth communication with an in-vehicle head unit, includes: enabling a Bluetooth function and a discoverable mode of the user device; establishing a logical link with the in-vehicle head unit; receiving a connection request message from the in-vehicle head unit through the established logical link; displaying a pop-up notification window for user approval of a connection request that is indicated by the connection request message; and determining whether the connection request has been approved of based on a user-inputted passkey value in the pop-up notification window.

The Bluetooth pairing method may further include transmitting an approval completion message to the in-vehicle head unit when approval of the connection request is determined.

The connection request message may include vehicle information and a passkey value corresponding to the in-vehicle head unit, and approval of the connection request may be determined when the user-inputted passkey value is identical to the passkey value included in the connection request message.

The pop-up notification window may display at least one of the vehicle information and the passkey value included in the connection request message.

Furthermore, according to embodiments of the present disclosure, a computer readable recording medium in which a program to execute the above-described methods is recorded is provided.

Furthermore, according to embodiments of the present disclosure, an in-vehicle head unit having Bluetooth capability includes: a means configured to initiate a Bluetooth automatic connection procedure with a pre-registered first user device upon application of power; a means configured to cancel the commenced automatic connection procedure in accordance with user input; a means configured to search for a connectable user device; a means configured to establish a logical link with the searched user device; and a means to transmit a connection request message to the searched user device through the established logical link.

The logical link may be an ACL link, and a maximum number of ACL links which are permitted to be simultaneously established in the in-vehicle head unit may be predefined.

The in-vehicle head unit may further include a means configured to measure a received signal strength indicator (RSSI) of a plurality of searched user devices, the searched user device being one of the plurality of searched user devices; and a means configured to store address information of the searched user devices and arrange the stored address information according to the measured RSSI, wherein the connection request message may be sequentially transmitted to each of the searched user devices in an order according to the arranged address information.

The connectable user device may be a user device having an enabled Bluetooth function and an enabled discoverable mode.

The in-vehicle head unit may further include a means configured to receive an approval completion message from the user device after transmission of the connection request message, and the in-vehicle head unit may perform Bluetooth communication with the user device.

Furthermore, according to embodiments of the present disclosure, a user device being capable of Bluetooth communication with an in-vehicle head unit, includes: a means configured to enable a Bluetooth function and a discoverable mode in accordance with a user menu selection; a means configured to establish a logical link with the in-vehicle head unit; a means configured to receive a connection request message from the in-vehicle head unit through the established logical link; a means configured to display a pop-up notification window for user approval of a connection request indicated by the connection request message; and a means configured to check whether the connection request has been approved based on a user-inputted passkey value in the pop-up notification window, wherein the user device transmits an approval confirmation message to the in-vehicle head unit when the connection request has been approved.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a view illustrating a conventional in-vehicle Bluetooth pairing procedure;

FIG. 2 is a view illustrating a user interface screen output to an in-vehicle head unit during the conventional Bluetooth pairing procedure;

FIG. 3 is a view showing a configuration of an in-vehicle Bluetooth pairing system according to embodiments of the present disclosure;

FIG. 4 is a view illustrating an in-vehicle Bluetooth pairing procedure according to embodiments of the present disclosure;

FIG. 5 is a view illustrating a user interface screen output to an in-vehicle head unit during the Bluetooth pairing procedure according to embodiments of the present disclosure;

FIG. 6 is a flowchart illustrating a Bluetooth pairing procedure according to embodiments of the present disclosure; and

FIG. 7 is a table illustrating user device search results according to embodiments of the present disclosure.

### DETAILED DESCRIPTION OF THE EMBODIMENTS

Reference will now be made in detail to embodiments of the present disclosure, examples of which are illustrated in the accompanying drawings. The suffixes “module” and “unit” of elements herein are used for convenience of description and thus can be used interchangeably and do not have any distinguishable meanings or functions.

Although all elements constituting embodiments of the present disclosure are described so as to be integrated into a single one or to be operated as a single one, the present disclosure is not necessarily limited to such embodiments. According to embodiments, all of the elements may be selectively integrated into one or more and be operated as one or more within the object and the scope of the present disclosure. Each of the elements may be implemented as independent hardware.

To this point, it is understood that one or more of the below methods, or aspects thereof, may be executed by at least one controller. The term “controller” may refer to a hardware device that includes a memory and a processor. The memory is configured to store program instructions, and the processor is configured to execute the program instructions to perform one or more processes which are described further below. Moreover, it is understood that the below methods may be executed by an apparatus comprising the controller.

Alternatively, some or all of the elements may be selectively combined into a computer program having a program module performing some or all functions combined in one or more pieces of hardware. A plurality of codes and code segments constituting the computer program may be easily reasoned by those skilled in the art to which the present disclosure pertains. The computer program may be stored in a computer readable media such that the computer program is read and executed by a computer to implement embodiments of the present disclosure. Computer program storage media may include magnetic recording media, optical recording media, and carrier wave media.

The term “comprises”, “includes”, or “has” described herein should be interpreted not to exclude other elements but to further include such other elements since the corresponding elements may be inherent unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless obviously defined in the present disclosure, such terms are not interpreted as ideal or excessively formal meanings.

It will be understood that, although the terms first, second, A, B, (a), (b), etc. may be used herein to describe various elements of the present disclosure, these terms are only used to distinguish one element from another element and essential, order, or sequence of corresponding elements are not limited by these terms. It will be understood that when one element is referred to as being “connected to”, “coupled to”, or “accessed by” another element, one element may be “connected to”, “coupled to”, or “accessed by” another element via a further element although one element may be directly connected to or directly accessed by another element.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

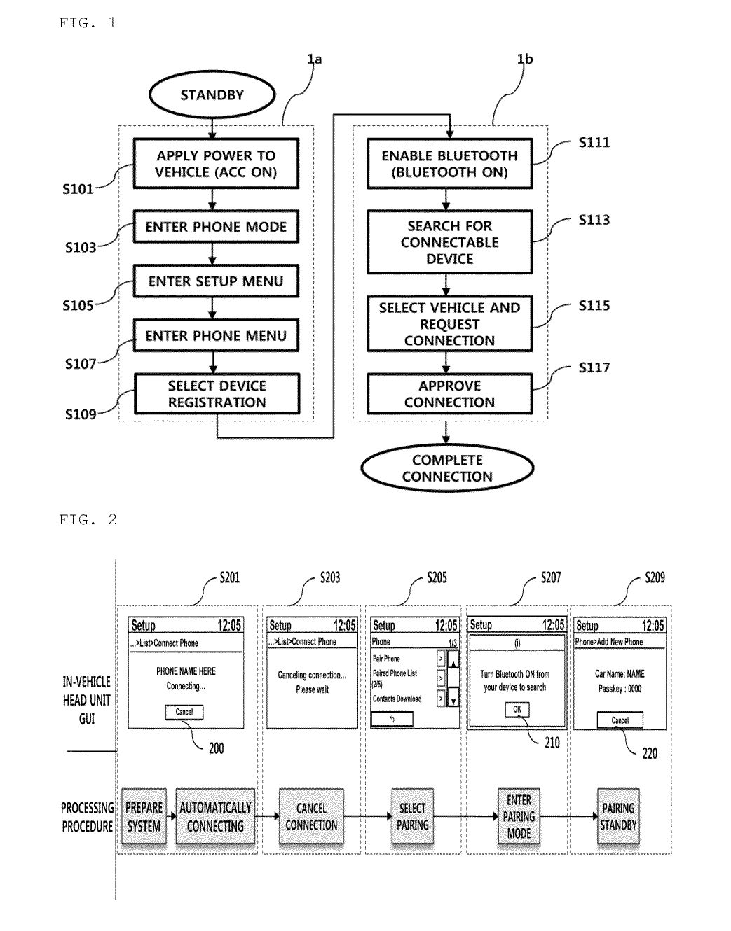

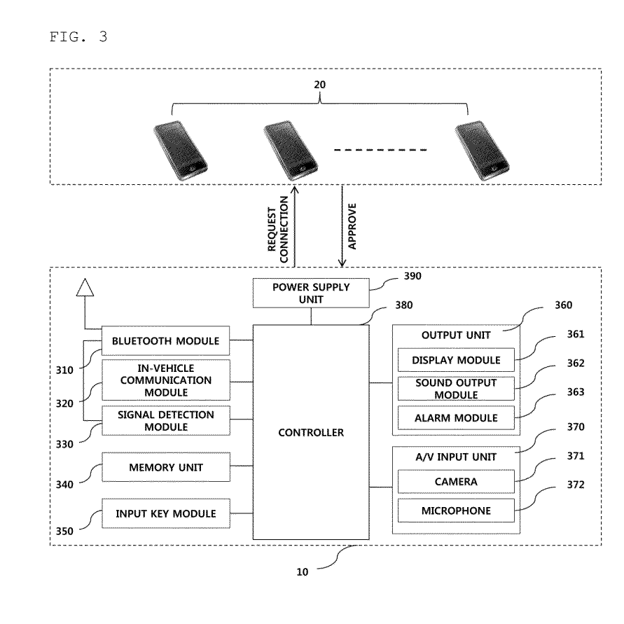

Hereinafter, a conventional in-vehicle Bluetooth pairing procedure will be described in brief with reference to FIGS. 1 and 2.

FIG. 1 is a view illustrating a conventional in-vehicle Bluetooth pairing procedure. Reference numeral 1a denotes a Bluetooth pairing procedure performed in an in-vehicle head unit, and reference numeral 1b denotes a Bluetooth pairing procedure performed in a user device.

Referring to reference numeral 1a, when a user starts a vehicle and, therefore, power is applied to the vehicle (i.e., ACC ON) and a vehicle system is prepared, an in-vehicle head unit (H/U) commences (e.g., initiates) an automatic Bluetooth pairing procedure. At this time, the in-vehicle head unit enters a phone mode to attempt to pair with a pre-designated or pre-registered user device, e.g., a driver's smartphone (S101 and S103). In addition, a predetermined user interface screen showing that connection to a specific device is being attempted may be configured and displayed on a display screen of the in-vehicle head unit.

When the pairing procedure automatically performed after starting of the vehicle is canceled by the user, the in-vehicle head unit may sequentially enter a setup menu and a phone menu to configure and display a predetermined user interface screen including a menu item for registering a new user device or selecting one of pre-registered user devices, which will hereinafter be referred to as a “device registration selection screen” for the convenience of description (S105 to S109). At this time, the user may designate a user device for pairing according to menu selection on the device registration selection screen. In addition, a predetermined guide message indicating to enable a Bluetooth function of the user device for pairing may be displayed on the display screen of the in-vehicle head unit.

Referring to reference numeral 1b, the user may enable a Bluetooth function of the user device according to the guide message displayed on the screen of the in-vehicle head unit (S111). When the Bluetooth function of the user device is enabled by the user, the user device may search for surrounding devices that are capable of performing Bluetooth pairing and display the search result on the screen (S113).

When the user selects their vehicle based on the search result displayed on the screen, the user device transmits a connection request signal to the selected vehicle (S115). At this time, a predetermined passkey input screen for inputting a passkey value corresponding to the selected vehicle may be displayed on the screen of the user device.

Upon receiving the connection request signal from the user device, the in-vehicle head unit may display vehicle information and the passkey value on the screen. When the passkey value is input to the passkey input screen, the user device transmits the passkey value to the in-vehicle head unit. Determining that the received passkey value is identical to a passkey value of the in-vehicle head unit, the in-vehicle head unit may transmit a predetermined approval completion message indicating that the connection request has been approved to the user device (S117).

FIG. 2 is a view illustrating a user interface screen output to the in-vehicle head unit during the conventional Bluetooth pairing procedure.

Referring to FIG. 2, when the user starts the vehicle and an automatic pairing procedure is commenced, the in-vehicle head unit may output an automatic connection screen informing that Bluetooth connection to a specific user device is being performed (S201). At this time, when the user clicks a “cancel” button 200 on the automatic connection screen to cancel the automatic fairing, the in-vehicle head unit may display a screen for registering or selecting a device for pairing (S203 and S205).

Subsequently, when the device for pairing is designated by the user, the in-vehicle head unit may display a predetermined Bluetooth connection guide message indicating to enable a Bluetooth function of the designated device on the screen (S207). At this time, the user may enable the Bluetooth function of the designated device according to the Bluetooth connection guide message.

Subsequently, when the user clicks an OK button 210, the in-vehicle head unit displays a vehicle name and a passkey value to be used to register a new device on the screen and enters a pairing standby state (S209). When a “cancel” button 220 is selected in the pairing standby state, the in-vehicle head unit may finish the pairing procedure.

In another example, a conventional in-vehicle Bluetooth pairing method using a pairing application may be used. The user may download a pairing application from an Internet market and install the pairing application in the user device. Most of the pairing procedure is identical to the in-vehicle Bluetooth pairing procedure shown in FIGS. 1 and 2 except that, when the pairing application is driven, devices registered by the pairing application and available devices, such as a vehicle, a Bluetooth headset, a smartphone, and a mobile phone, are searched and the user may select and add the available devices to a registered device list.

In the in-vehicle Bluetooth pairing method using the pairing application, however, the pairing application must be downloaded and installed in the user device. Furthermore, the pairing application may not be compatible with all devices. For example, a specific pairing application may be operated only in devices based on an Android operation system. In addition, the number of user manipulation steps for pairing in the in-vehicle head unit is not reduced although the pairing application is used.

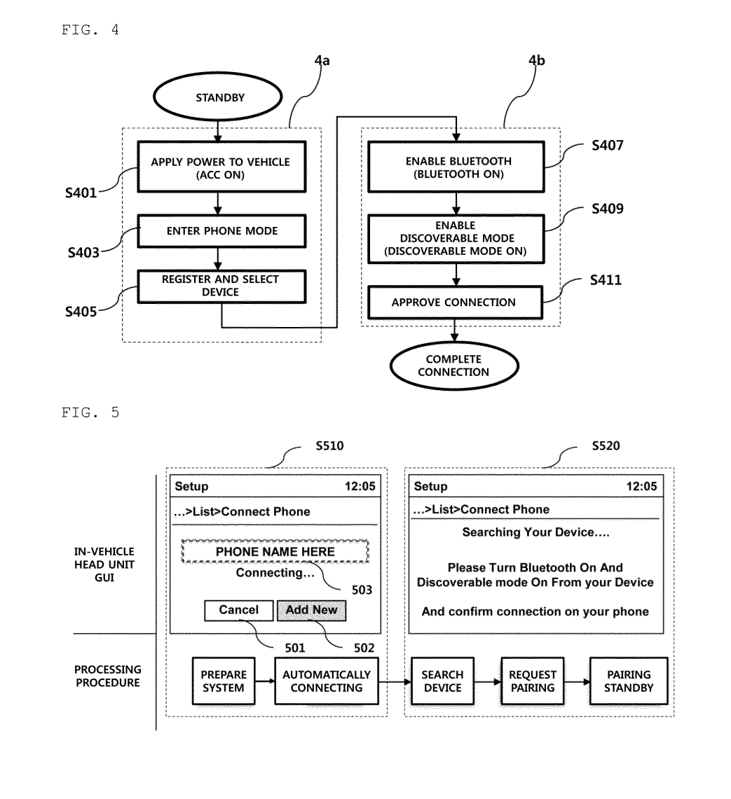

FIG. 3 is a view showing a configuration of a Bluetooth pairing system according to embodiments of the present disclosure.

As exemplarily shown in FIG. 3, the pairing system according to the present disclosure may include a user device 20 and an in-vehicle head unit 10. The in-vehicle head unit may include a Bluetooth module 310, an in-vehicle communication module 320, a signal detection module 330, a memory unit 340, an input key module 350, an output unit 360, an audio/video (A/V) input unit 370, a controller 380, and a power supply unit 390.

The Bluetooth module 310 may include a baseband module for processing a baseband signal according to a Bluetooth standard, a power amplifier for amplifying the baseband signal, a band pass filter (BPF) for converting the amplified baseband signal into a transmission frequency band or passing a signal having a desired frequency band selected from among radio frequency (RF) signals received through an antenna, a low noise amplifier for amplifying the band-passed RF signal to be easily recognized and transmitting the RF signal to the baseband module, and an antenna for transmitting and receiving the RF signal.

The in-vehicle communication module 320 communicates with an electronic control unit (ECU) equipped in the vehicle. For example, when the vehicle is started, the in-vehicle communication module 320 may receive a control signal indicating ACC ON from the ECU that senses starting of the vehicle and transmit the control signal to the controller 380. The controller 380 may apply power to the in-vehicle head unit and commence an automatic pairing procedure.

The signal detection module 330 may detect a received signal strength indicator (RSSI) from an external device and measure strength of the detected signal. In addition, the signal detection module 330 may select and sort an external user device 20 that can be paired based on the strength of the detected signal and transmit the external user device 20 to the controller 380. At this time, the signal detection module 330 may transmit an RSSI read command to a link management protocol (LMP) layer, which is a protocol layer that performs link setup between Bluetooth devices, of the Bluetooth module 310 to acquire an RSSI value of a signal received from the user device 20. At this time, the RSSI value may be detected only when a discoverable mode of the user device 20 is enabled. The discoverable mode may be set through selection of a predetermined menu item of the user device 20.

In addition, the signal detection module 330 may acquire address information, which includes at least one of a unique Bluetooth address uniquely assigned to a corresponding device and a media access control (MAC) address assigned to the corresponding device, corresponding to the RSSI-detected user device 20 and store the address information together with the detected RSSI level. At this time, the address information may be arranged in high order of the RSSI value and stored in the memory unit 340.

In addition, the signal detection module 330 may be controlled to detect the RSSI for a predetermined number of user devices 20. Generally, Bluetooth enables both data communication sensible to delay time, such as voice or audio, and packet data communication performed at high speed and insensible to delay time. Two different links are defined between two Bluetooth devices to transmit such data. A synchronous connection oriented (SCO) link may be set for the voice communication sensible to the delay time and an asynchronous connectionless (ACL) link may be set for the packet data communication insensible to the delay time.

The signal detection module 330 according to embodiments of the present disclosure may recognize the number of user devices 20, the RSSI of which is to be detected, according to a predetermined maximum asynchronous connectionless (ACL) link value. For example, when the maximum ACL link (Max ACL Link) value is set to 5, the signal detection module 330 may detect the RSSI for a maximum of 5 user devices 20.

Generally, in a case in which a discoverable mode of a user device is enabled via selection of a predetermined menu and the user device is an Android device, the discoverable mode may be maintained only for approximately two minutes. Therefore, the number of user devices searched by the in-vehicle head unit 10 while the discoverable mode is enabled may not exceed a maximum of five.

Although the in-vehicle head unit 10 has been described above as measuring the RSSI of the user device 20 in the discoverable mode and performing pairing with the corresponding user device 20 based on the measured RSSI by way of example, this is only one example. Furthermore, according to embodiments of the present disclosure, when the discoverable mode of the user device 20 is enabled, regardless of the RSSI level of the user device 20, the in-vehicle head unit 10 may set logical links equal in number to a predefined maximum of ACL links and automatically perform pairing with the user device 20, the discoverable mode of which is enabled, through the set logical links. Accordingly, the user device 20 no longer needs to perform a vehicle search step as well as a vehicle selection step and connection attempt step based on the search result, which are included in the conventional pairing procedure.

In conclusion, the present disclosure may simplify user manipulation steps upon implementation of pairing between the in-vehicle head unit 10 and the user device 20 and simultaneously perform pairing with a plurality of user devices through a plurality of logical links.

The memory unit 340 may store programs for operating the controller 380 and lower modules controlled by the controller 380 and temporarily store input/output data (for example, an address book, messages, still images, videos, and application programs). The application programs may include programs for navigation, games, chatting, web surfing, schedule management, multimedia reproduction, and the like.

In particular, the memory unit 340 according to the present disclosure may store an application program for Bluetooth pairing and address information of the user devices 20 arranged according to RSSI values. In addition, the memory unit 340 may store data on various vibration and sound patterns output at the time of touch input on a touchscreen.

The memory unit 340 may include at least one selected from among a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The input key module 350 generates input data for controlling operation of the in-vehicle head unit 10. The input key module 350 may include a key pad, a dome switch, a touch pad (e.g., static pressure/electrostatic), a jog wheel, and a jog switch.

The output unit 360 generates an output relevant to a sense of sight, hearing, or touch. The output unit 360 may include a display module 361, a sound output module 352, and an alarm module 363.

The display module 361 displays or outputs information processed by the in-vehicle head unit 10. For example, when the in-vehicle head unit 10 is in a telephone conversation mode, the display module 361 displays a user interface (UI) or graphical user interface (GUI) related to telephone conversation. On the other hand, when the in-vehicle head unit 10 is in a navigation mode, the display module 361 displays a user interface (UI) or graphical user interface (GUI) related to travel guide.

In particular, the display module 361 may configure and display information regarding automatic pairing progress state and a pairing-related menu in a pairing mode as a user interface (UI) or graphical user interface (GUI). The display module 361 may include at least one selected from among a liquid crystal display, a thin film transistor-liquid crystal display, an organic light-emitting diode, a flexible display, and a three-dimensional (3D) display.

According to configuration of the in-vehicle head unit 10, two or more display modules 361 may be provided. For example, the display modules 361 may be disposed at one side of the in-vehicle head unit 10 separately or integrally. Alternatively, the display modules 361 may be disposed at opposite sides of the in-vehicle head unit 10.

In a case in which the display module 361 and a sensor for sensing a touch (hereinafter, referred to as a “touch sensor”) constitute a mutual layer structure (hereinafter, simply referred to as a “touchscreen”), the display module 361 may be used as an input device in addition to an output device.

The touch sensor may be configured as a touch film, a touch sheet, or a touchpad. The touch sensor may be configured to convert pressure applied to a specific portion of the display module 361 or change of capacitance generated from a specific portion of the display module 361 to an electric input signal. The touch sensor may be configured to sense pressure of a touch as well as a touched position and area.

When a touch input is made to the touch sensor, a signal(s) corresponding to the touch is transmitted to a touch controller. The touch controller processes the signal(s) and then transmits data corresponding to the processed signal(s) to the controller 380. Therefore, the controller 380 may recognize which portion of the display module 361 has been touched

The sound output module 362 may output audio data received from the Bluetooth module 310 or stored in the memory unit 340 in a call signal reception mode, a telephone conversation mode, a recording mode, a speech recognition mode, or a pairing mode. The sound output module 362 outputs a sound signal related to a function (e.g., a call signal reception sound, a message reception sound, or a pairing completion sound) performed by the in-vehicle head unit 10. The sound output module 362 may include a receiver, a speaker, and a buzzer. In addition, the sound output module 362 may output sound through an earphone jack provided at one side of the in-vehicle head unit 10.

The alarm module 363 outputs signals for notifying that events have been generated in the in-vehicle head unit 10. Examples of events generated in the in-vehicle head unit 10 may include call signal reception, message reception, key signal input, touch input, and reception of vehicle state information from the in-vehicle communication module 320. The vehicle state information may include door opening information, engine overheating information, lane deviation information, and fuel state information. The alarm module 363 may output other different signals, such as vibration signals for notifying of event generation, in addition to video signals or audio signals. The video signals or the audio signals may also be output through the display module 361 or the sound output module 362.

The A/V input unit 370 is provided to input audio signals or video signals. The A/V input unit 370 may include a camera 371 and a microphone 372.

The camera 371 processes image frames, such as still images or videos, acquired by an image sensor in a video conversation mode or in a capturing mode. The processed image frames may be displayed on the display module 361. In addition, the camera 371 may capture images behind the vehicle when the vehicle is moved backward. The captured images may be output through the display module 361.

The image frames processed by the camera 371 may be stored in the memory unit 340 or transmitted to a paired user device 20 via the Bluetooth module 310. According to configuration of the in-vehicle head unit 10 and the vehicle, two or more cameras 371 may be provided.

The microphone 372 receives external sound signals and converts the received sound signals into electrical speech data in a telephone conversation mode, a recording mode, or a speech recognition mode. In the telephone conversation mode, the converted speech data may be transmitted to the paired user device 20 through the Bluetooth module 310.

The power supply unit 390 supplies power necessary to operate the in-vehicle head unit 10. When the vehicle is powered ON, the power supply unit 390 may automatically supply power to the in-vehicle head unit 10. When the vehicle is powered OFF, the power supply unit 390 may automatically interrupt the supply of power to the in-vehicle head unit 10.

The controller 380 generally controls overall operation of the in-vehicle head unit 10. For example, the controller 380 may control a communication function including speech communication using Bluetooth pairing, data communication, and video communication. In addition, the controller 380 may control an application program to be installed and driven.

In addition, the controller 380 may perform pattern recognition processing that is capable of recognizing a writing input or a drawing input performed on the touchscreen as text and images. In particular, the controller 380 may control input and output operations according to various control signals received from the lower modules and provide a user interface screen based thereupon. The lower modules may include the Bluetooth module 310, the in-vehicle communication module 320, the signal detection module 330, the memory unit 340, the input key module 350, the output unit 360, the A/V input unit 370, and the power supply unit 390 as previously described.

Particularly, upon sensing of at least one user device, the discoverable mode of which is enabled, the controller 380 according to embodiments of the present disclosure may set a predetermined maximum number of ACL logical links with the corresponding user device and control implementation of pairing request and phonebook download procedures through the set ACL logical links.

Furthermore, according to embodiments of the present disclosure, the controller 380 may determine a pairing sequence based on a measured RSSI level on a per user device 20 basis, set an ACL link with the corresponding user device 20 according to the determined pairing sequence, and control implementation of pairing request and phonebook downward procedures through the set ACL link.

FIG. 4 is a view illustrating an in-vehicle Bluetooth pairing procedure according to embodiments of the present disclosure.

Reference numeral 4a denotes a Bluetooth pairing procedure performed in the in-vehicle head unit 10 and reference numeral 4b denotes a Bluetooth pairing procedure performed in the user device 20. When the vehicle is started and power is applied to the in-vehicle head unit 10, the in-vehicle head unit 10 may enter a phone mode and then detect and register a Bluetooth connectable user device 20 (S401 to S405). At this time, the in-vehicle head unit 10 may detect only the user device 20, a discoverable mode of which is enabled, and transmit a connection request message to the detected user device 20 through an ACL link. In this case, the number of ACL links may be set to a predefined maximum value. That is, the in-vehicle head unit 10 may be simultaneously connected to user devices 20 that are equal in number to a predefined maximum of ACL links. Here, the connection request message may include vehicle information and a passkey value corresponding to the in-vehicle head unit 10 that has transmitted the corresponding connection request message. The vehicle information may include at least one of vehicle model name information, model year information, vehicle registration number information, and vehicle color information.

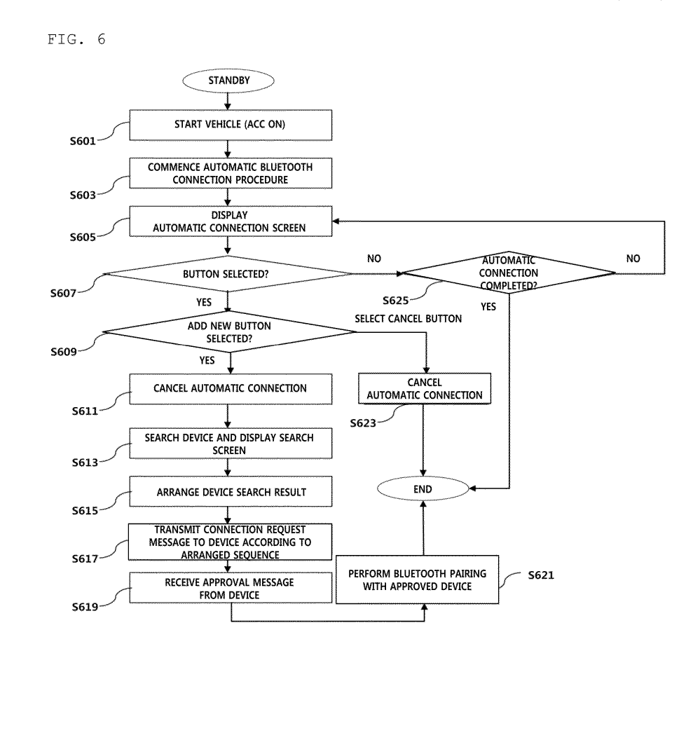

It should be noted that reference numeral 4a does not clearly show a step in which an automatic pairing procedure is commenced after the vehicle is started and a step in which the user selects a predetermined menu item (designated by reference numeral 502 in FIG. 5) in order to add a new device.

Referring to reference numeral 4b, according to a prescribed guide message output to the screen of the in-vehicle head unit 10 (see step S510 in FIG. 5 that will be described below), the user may enable a Bluetooth function and a discoverable mode of the user device 20 (S407 and S409).

Upon reception of a connection request message from the in-vehicle head unit 10 through the ACL link, the user device 20 may display a predetermined pop-up notification window for approval on the screen and transmit an approval completion message to the in-vehicle head unit 10 according to user input to complete pairing (S411).

At this time, information displayed on the pop-up notification window may include information regarding a connection requested vehicle (e.g., vehicle model name, model year, and vehicle registration number), predetermined passkey information regarding the corresponding vehicle (here, the passkey information may include personal identification number (PIN) code information composed of numerals, and a password composed of at least one combination of numerals, letters, and symbols). The PIN code information may be composed of six numerals and used as a means for vehicle authentication. For example, the pop-up notification window for approval may include a PIN code input box for reception of a PIN code input by the user. When a user input PIN code is identical to a PIN code received through the connection request message, success of approval may be judged.

FIG. 5 is a view illustrating a user interface screen output to the in-vehicle head unit during the Bluetooth pairing procedure according to embodiments of the present disclosure.

Referring to FIG. 5, when the vehicle is powered ON and power is applied to the in-vehicle head unit 10, the in-vehicle head unit 10 commences an automatic pairing procedure with a pre-designated user device 20 (S510). At this time, the in-vehicle head unit 10 may display a predetermined automatic connection screen including a name 503 of a user device to which the in-vehicle head unit 10 is attempting to automatically connect. At this time, the automatic connection screen may include a “cancel” button 501 for cancelling the automatic connection procedure that is underway, and an “add new” button 502 for registration and selection of a new user device.

When the user selects the “add new” button 502 on the automatic connection screen, the in-vehicle head unit 10 may search for a connectable user device and transmit a pairing request message to the corresponding user device 20 based on the search result. Subsequently, the in-vehicle head unit 10 may await reception of an approval completion message from the user device 20 (S520).

At this time, as exemplarily shown in step S520, the in-vehicle head unit 10 may display a device search screen including a string guiding that the in-vehicle head unit 10 is searching for a device, a string guiding to enable a Bluetooth function and a discoverable mode, and a string guiding to perform an approval with respect to a connection request in the user device 20.

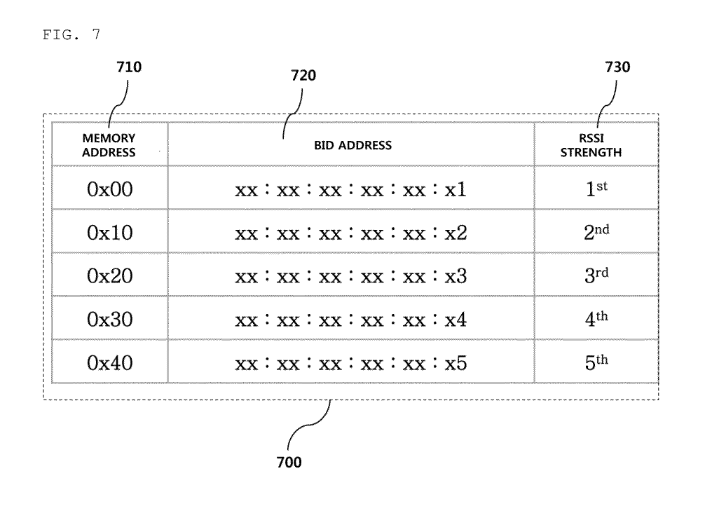

FIG. 6 is a flowchart illustrating a Bluetooth pairing procedure according to embodiments of the present disclosure.

Referring to FIG. 6, when the vehicle is powered ON and power is applied to the in-vehicle head unit 10, the in-vehicle head unit 10 commences a Bluetooth automatic connection procedure with a pre-designated user device 20 (S601 and S603).

At this time, the in-vehicle head unit 10 may display an automatic connection screen including the “cancel” button 501 for cancelling the automatic connection procedure that is underway and the “add new” button 502 for searching/registering/selecting a new user device (S605).

Upon selection of any one of the buttons, the in-vehicle head unit 10 checks (e.g., determines) whether the “add new” button 502 is selected (S607 and S609). When the checked result shows selection of the “add new” button 502, the in-vehicle head unit 10 may cancel the automatic connection procedure that is underway, search for a connectable user device 20, and display a predetermined device search screen notifying that the in-vehicle head unit 10 is searching for a user device (S611 and S613).

Subsequently, the in-vehicle head unit 10 arranges the user device search result based on an RSSI level and sets ACL links according to the arranged sequence to transmit a connection request message to a corresponding user device 20 (S615 and S617). Here, a predefined maximum number of ACL links may be set. Furthermore, according to embodiments of the present disclosure, instead of measuring an RSSI on a per user device basis and determining a transmission sequence of a connection request message to user devices 20 based on the measured RSSI level, the in-vehicle head unit 10 may assign ACL links and transmit a connection request message according to a searched sequence of user devices 20.

Upon receiving a predetermined approval confirmation message notifying that the user approves the connection request from the user device 20, the in-vehicle head unit 10 sets Bluetooth communication with the corresponding user device 20 and completes pairing (S619 and S621). When no button is selected in step S607, the in-vehicle head unit 10 judges whether the automatic connection procedure is completed (S625). Judging in step S625 that the automatic connection procedure is not completed, the method returns to step S605. On the other hand, judging that the automatic connection procedure is completed, pairing is completed.

FIG. 7 is a view illustrating a user device search result table according to embodiments of the present disclosure.

Referring to FIG. 7, the user device search result table 700 may include a memory address field 710, a board identification address (BID) field 720, and an RSSI level field 730. The memory address field 710 may be address information recorded in a memory in which the corresponding BID field 720 and RSSI level field 730 are recorded. For example, the memory address field 710 may be beginning address information of a region in which the corresponding BID field 720 and RSSI level field 730 are recorded among pre-assigned recording regions for the user device search result table 700.

The BID field 720 may be a fixed Bluetooth address assigned to a Bluetooth module equipped in a corresponding user device or a media access control (MAC) address assigned to the corresponding user device.

The RSSI level field 730 may be ranking information determined according to measured RSSI values received from corresponding user devices. The in-vehicle head unit 10 according to the present disclosure may measure respective RSSIs for a plurality of user devices and determine the ranking of the user devices according to the measured RSSI values. For example, the highest RSSI level may be ranked first, and the second highest RSSI level may be ranked second, and so forth. The user device having the highest RSSI level may be located closest to the in-vehicle head unit 10.

Particularly, the in-vehicle head unit 10 according to the present disclosure may preferentially transmit a connection request message to a user device having a higher RSSI ranking. In the case of simultaneously receiving approval messages for a connection request from different user devices, the in-vehicle head unit 10 may control Bluetooth pairing with a user device having a higher RSSI ranking.

As is apparent from the above description, a method and apparatus according to the present disclosure have the following effects. For example, the present disclosure has an advantage of providing an in-vehicle Bluetooth pairing method that is: 1) more rapid and convenient due to simplified user pairing operation steps; 2) capable of simultaneously requesting several in-vehicle user devices for pairing by setting a plurality of logical links with the user devices; and 3) capable of simultaneously pairing with a plurality of user devices based on the quality of radio signals received from the user devices, thereby simplifying user manipulation steps.

It will be appreciated by persons skilled in the art that the effects that can be achieved through the present disclosure are not limited to what has been particularly described hereinabove and other advantages of the present disclosure will be more clearly understood from the above detailed description. It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A Bluetooth pairing method in an in-vehicle head unit comprising:
initiating a Bluetooth automatic connection procedure with a pre-registered first user device upon application of power;
canceling the initiated automatic connection procedure in accordance with user input;
searching for a connectable user device;
establishing a logical link with the searched user device; and
transmitting a connection request message to the user device through the established logical link.

2. The Bluetooth pairing method according to claim 1, wherein the logical link is an asynchronous connectionless (ACL) link, and a maximum number of ACL links which are permitted to be simultaneously established in the in-vehicle head unit is predefined.

3. The Bluetooth pairing method according to claim 1, further comprising:
when a plurality of user devices is searched, the searched user device being one of the plurality of user devices, measuring a received signal strength indicator (RSSI) of each searched user device,
wherein address information corresponding to each of the searched user devices is stored in a memory and arranged therein according to the measured RSSI.

4. The Bluetooth pairing method according to claim 3, wherein the address information includes at least one of media access control (MAC) address information corresponding to the searched user devices and Bluetooth address information assigned to Bluetooth modules equipped in the searched user devices, and the connection request message is transmitted using the address information.

5. The Bluetooth pairing method according to claim 3, further comprising:
ranking the searched user devices according to the measured RSSI; and
sequentially transmitting the connection request message to each of the searched user devices in an order according to the ranking.

6. The Bluetooth pairing method according to claim 3, wherein the RSSI is measured in a link management protocol (LMP) layer of a Bluetooth module equipped in the in-vehicle head unit.

7. The Bluetooth pairing method according to claim 1, wherein the connectable user device is a user device having an enabled Bluetooth function and an enabled discoverable mode.

8. The Bluetooth pairing method according to claim 1, wherein the connection request message includes vehicle information and a passkey value corresponding to the in-vehicle head unit.

9. The Bluetooth pairing method according to claim 8, wherein the user device, after receiving the connection request message, displays a predetermined pop-up notification window for approval on a screen thereof, and the pop-up notification window displays the vehicle information and the passkey value.

10. The Bluetooth pairing method according to claim 9, wherein approval of a connection request that is indicated by the connection request message occurs when a user-inputted passkey value is identical to the passkey value displayed in the pop-up notification window.

11. The Bluetooth pairing method according to claim 1, further comprising:
displaying an automatic connection screen including a “cancel” button and an “add new” button upon initiation of the automatic connection procedure,
wherein the connectable user device is searched for upon selection of the “add new” button.

12. A Bluetooth pairing method in a user device, the user device being capable of Bluetooth communication with an in-vehicle head unit, the Bluetooth pairing method comprising:
enabling a Bluetooth function and a discoverable mode of the user device;
establishing a logical link with the in-vehicle head unit;
receiving a connection request message from the in-vehicle head unit through the established logical link;
displaying a pop-up notification window for user approval of a connection request that is indicated by the connection request message; and
determining whether the connection request was approved of based on a user-inputted passkey value in the pop-up notification window.

13. The Bluetooth pairing method according to claim 12, further comprising:
transmitting an approval completion message to the in-vehicle head unit when approval of the connection request is determined.

14. The Bluetooth pairing method according to claim 12, wherein the connection request message includes vehicle information and a passkey value corresponding to the in-vehicle head unit, and approval of the connection request is determined when the user-inputted passkey value is identical to the passkey value included in the connection request message.

15. The Bluetooth pairing method according to claim 14, wherein the pop-up notification window displays at least one of the vehicle information and the passkey value included in the connection request message.

16. An in-vehicle head unit having Bluetooth capability comprising:
a means configured to initiate a Bluetooth automatic connection procedure with a pre-registered first user device upon application of power;
a means configured to cancel the commenced automatic connection procedure in accordance with user input;
a means configured to search for a connectable user device;
a means configured to establish a logical link with the searched user device; and
a means configured to transmit a connection request message to the searched user device through the established logical link.

17. The in-vehicle head unit according to claim 16, wherein the logical link is an ACL link, and a maximum number of ACL links which are permitted to be simultaneously established in the in-vehicle head unit is predefined.

18. The in-vehicle head unit according to claim 16, further comprising:
a means configured to measure a received signal strength indicator (RSSI) of a plurality of searched user devices, the searched user device being one of the plurality of searched user devices; and
a means configured to store address information of the searched user devices and arrange the stored address information according to the measured RSSI,
wherein the connection request message is sequentially transmitted to each of the searched user devices in an order according to the arranged address information.

19. The in-vehicle head unit according to claim 16, wherein the connectable user device is a user device having an enabled Bluetooth function and an enabled discoverable mode.

20. The in-vehicle head unit according to claim 16, further comprising a means configured to receive an approval completion message from the user device after transmission of the connection request message,
wherein the in-vehicle head unit performs Bluetooth communication with the user device.

21. A user device being capable of Bluetooth communication with an in-vehicle head unit, the user device comprising:
a means configured to enable a Bluetooth function and a discoverable mode in accordance with a user menu selection;
a means configured to establish a logical link with the in-vehicle head unit;
a means configured to receive a connection request message from the in-vehicle head unit through the established logical link;
a means configured to display a pop-up notification window for user approval of a connection request indicated by the connection request message; and
a means configured to check whether the connection request has been approved based on a user-inputted passkey value in the pop-up notification window,
wherein the user device transmits an approval confirmation message to the in-vehicle head unit when the connection request has been approved.

22. A non-transitory computer readable medium containing program instructions for performing a Bluetooth pairing method in an in-vehicle head unit, the computer readable medium comprising:
program instructions that initiate a Bluetooth automatic connection procedure with a pre-registered first user device upon application of power;
program instructions that cancel the initiated automatic connection procedure in accordance with user input;
program instructions that search for a connectable user device;
program instructions that establish a logical link with the searched user device; and
program instructions that transmit a connection request message to the user device through the established logical link.

23. A non-transitory computer readable medium containing program instructions for performing a Bluetooth pairing method in a user device being capable of Bluetooth communication with an in-vehicle head unit, the computer readable medium comprising:
program instructions that enable a Bluetooth function and a discoverable mode of the user device;
program instructions that establish a logical link with the in-vehicle head unit;
program instructions that receive a connection request message from the in-vehicle head unit through the established logical link;
program instructions that display a pop-up notification window for user approval of a connection request that is indicated by the connection request message; and
program instructions that determine whether the connection request was approved of based on a user-inputted passkey value in the pop-up notification window.
